(19) United States
(12) Patent Application Publication
(10) Pub. No.: US 2007/0257176 A1
(43) Pub. Date: Nov. 8, 2007

(54) Leg structure of office chair

(76) Inventor: Shu-Mu Lai, Taichung (TW)

Correspondence Address: PRO-TECHTOR INTERNATIONAL SERVICES, 20775 NORADA CT., SARATOGA, CA, 95070, US

(21) Appl. No.: 11/642,459

(22) Filed: Dec. 19, 2006

(30) Foreign Application Priority Data
May 5, 2006 (TW) 95116104

(51) Int. Cl. F16M 11/32

(52) U.S. Cl. 248/440.1

(57) ABSTRACT

A leg structure of an office chair comprises: a vertical support post coupled to the bottom of a support plate of an office chair, a leg coupled to the lower portion of support post, wherein the leg is defined with a fitting portion for the connection with the support post. At the periphery of fitting portion is outwardly arranged a plurality of leg racks in a radiation-shaped manner, and beneath the ends of leg racks are respectively provided with a sliding wheel, wherein an upright leg pillar is extendedly disposed at the lower end of the fitting portion, and a sliding wheel is mounted beneath the leg pillar for abutting against the floor, such that the leg pillar and the sliding wheel of leg pillar can support the weight of user so as to reduce the loading weights of leg racks of office chair, thus enabling to prolong the service lives of leg racks.

### BACKGROUND OF THE INVENTION

1. Field of the Invention

The present invention relates to a leg structure of an office chair which can support user's weight so as to reduce the loading weight of the leg racks of the chair, thus enabling to prolong the service lives of the leg racks.

2. Description of the Prior Arts

Referring to FIG. 1, a conventional chair comprises a soft seat cushion 11 disposed at the upper side of a support plate 10, the side of which is couplingly defined with a backing pad 12 for the user's comfortness. Furthermore, a vertical support post 13 is couplingly mounted at the central position of the bottom of the support plate 10, wherein the support post 13 is a rotatable adjusting screw or an air-compressed bar, accordingly, the supported weight of the support plate 10 will be passingly concentrated onto the support post 13 beneath which is couplingly defined with a leg 14 that is radially arranged a plurality of leg racks 141 so as to stably support the loading weight of the support post 13, and a sliding wheel 142 is provided at the lower side of each of the leg racks 141 so as to enhance the bearing area, thus the chair will not be easily overturned. Referring to FIG. 2, when each of the leg racks 141 of the leg 14 extends outwardly relative to the central line of the support post 13, although the bearing area can be increased so as to stably support the chair, the sliding wheel 142 of one end of each of the leg racks 141 will become a support point, while another end of each of the leg racks 141 has to bear the downwardly pressing force from the support post 13, hence a bending moment will occur. The longer length each of the leg racks 141 extends, the greater bending moment will form, and the break and unsafety of the racks 141 will consequently result in. To avoid such a problem, the bearing weight of the leg 14 must be maintained within the range of 1200-1600 ponds, hence the leg 14 has to be made of solid plastic material, such as polyamide fiber. However, such a material is quite expensive, especially its current price rises quickly, accordingly this conventional chair still has some defects that could be improved.

The present invention has arisen to mitigate and/or obviate the afore-described disadvantages.

### SUMMARY OF THE INVENTION

The primary object of the present invention is to provide a leg structure of an office chair that comprises a leg defined with a fitting portion for the connection with a support post, at the periphery of the fitting portion being radially arranged a plurality of leg racks, and beneath one end of each of the leg racks being provided with a sliding wheel, wherein an upright leg pillar is extendedly disposed at the lower end of the fitting portion, and another sliding wheel is mounted beneath the leg pillar for abutting against the ground such that the leg pillar and its sliding wheel can support the user's weight so as to reduce the loading weight of the leg racks of the chair, thus enabling to prolong the service lives of the leg racks.

The secondary object of the present invention is to provide a leg structure of an office chair that comprises an upright leg pillar extendedly disposed at the lower side of a fitting portion, and another sliding wheel mounted beneath the leg pillar for abutting against the ground, hence the loading weight of the leg racks of the chair can be reduced in such a manner that the leg can be made of cheaper plastic material, such as polypropylene so as to greatly diminish the material cost thereof.

Another object of the present invention is to provide a leg structure of an office chair, the lower side of the fitting portion of which is extendedly provided with the leg pillar in which a compression spring is mounted so as to absorb partial supported weight of the support post, thereby obtaining the stable support of the leg pillar and its sliding wheel.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of a conventional chair;

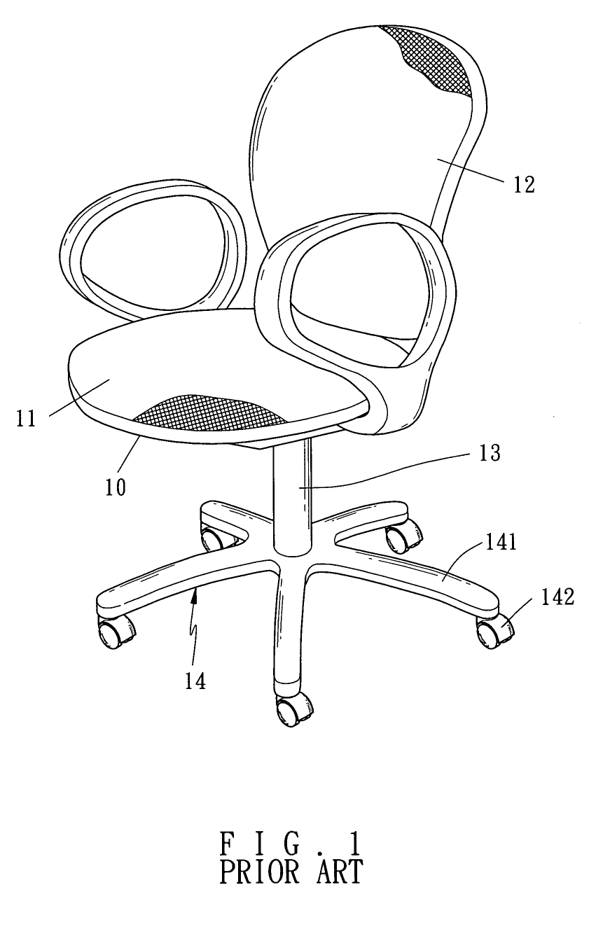

FIG. 2 is a cross sectional view of the conventional chair;

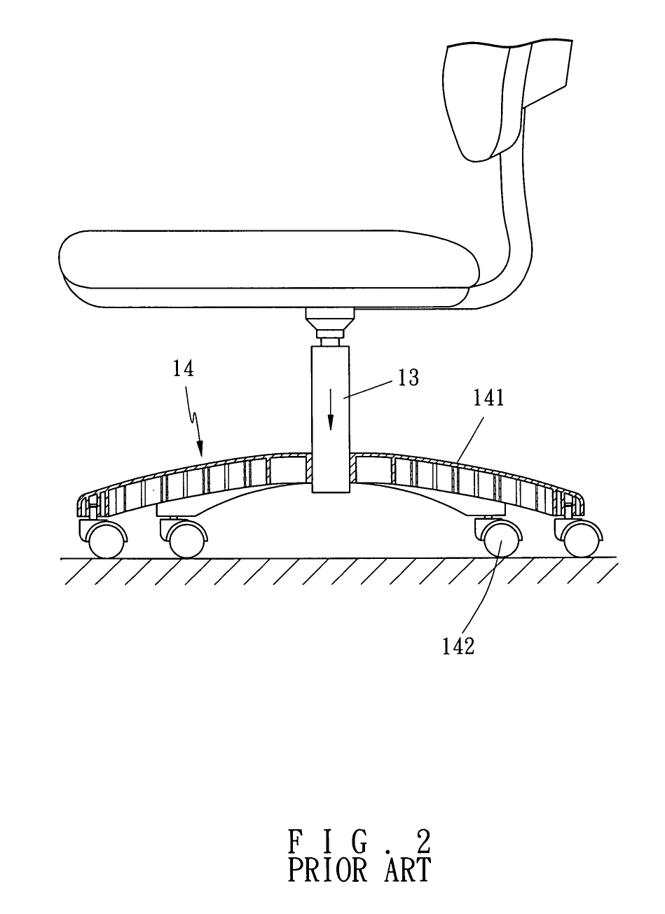

FIG. 3 is an exploded view of a leg structure of office chair in accordance with the present invention;

FIG. 4 is an assembly view of the leg structure of office chair in accordance with the present invention;

FIG. 5 is a cross sectional view of the leg structure of office chair in accordance with the present invention;

FIG. 6 is an exploded view of a leg structure of office chair in accordance with a first embodiment of the present invention;

FIG. 7 is a cross sectional view of the leg structure of office chair in accordance with the first embodiment of the present invention;

FIG. 8 is an exploded view of a leg structure of office chair in accordance with a second embodiment of the present invention;

FIG. 9 is an assembly view of the leg structure of office chair in accordance with the second embodiment of the present invention.

### DETAILED DESCRIPTION OF THE PREFERRED EMBODIMENT

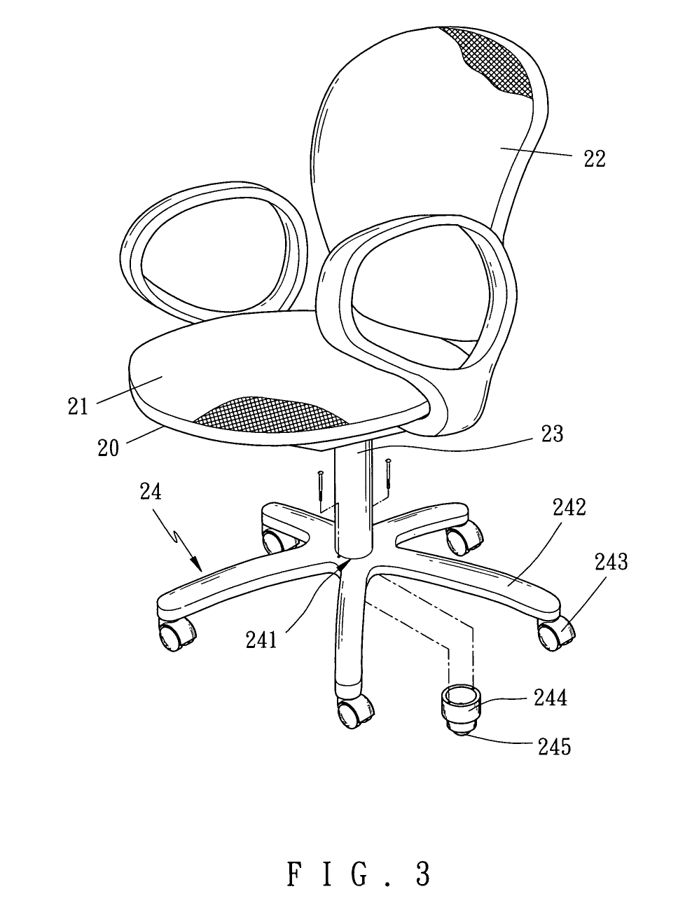

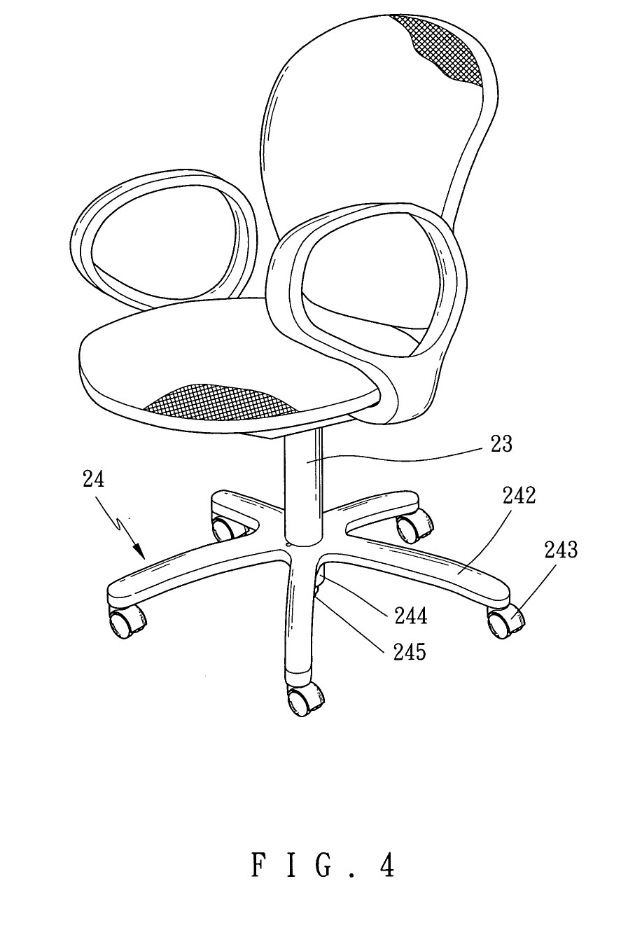

Referring to FIGS. 3-4, a leg structure of office chair in accordance with the present invention is shown and comprises a soft seat cushion 21 disposed at the upper side of a support plate 20, the side of which is couplingly defined with a backing pad 22 for the user's comfortness. Furthermore, a vertical support post 23 is couplingly mounted at the central position of the bottom of support plate 20, wherein the support post 23 is a rotatable adjusting screw or an air-compressed bar, accordingly the supported weight of support plate 20 will be passingly concentrated onto the support post 23 beneath which is couplingly defined with a leg 24 having a fitting portion 241, the periphery of which is radially arranged a plurality of leg racks 242, and a rotatable sliding wheel 243 is provided at the lower side of each of the leg racks 242, moreover, an upright leg pillar 244 is extendedly disposed at the lower end of the fitting portion 241 (the leg pillar 244 can also be integrally formed with the leg 24), and a ground-contacting member 245 is mounted beneath the leg pillar 244 for abutting against the ground, wherein the ground-contacting member 245 can be a rotatable sliding wheel or a wear-proof padding block.

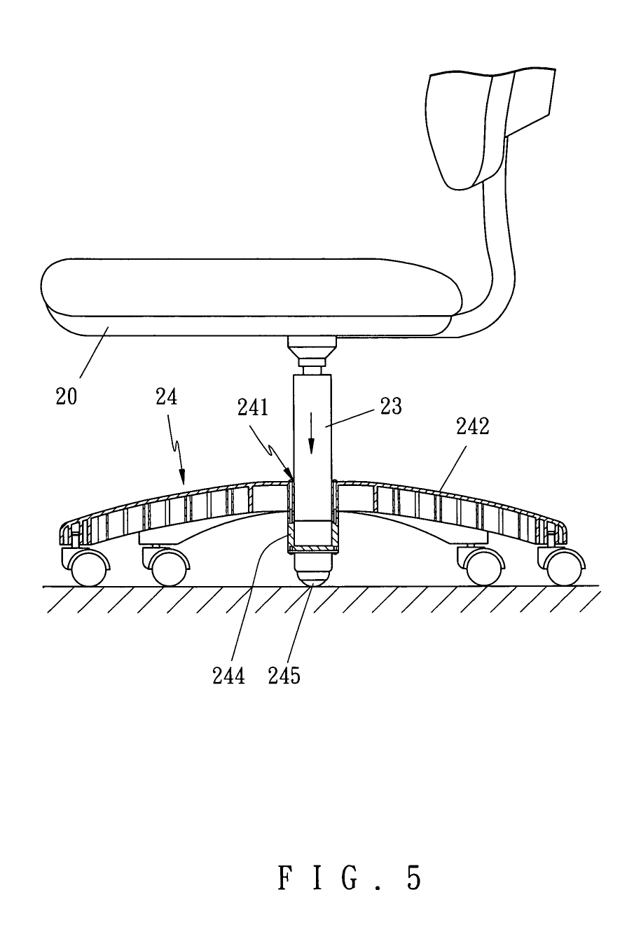

Referring further to FIG. 5, when the supported weight of support plate 10 presses downwardly, the downwardly-pressed force will be passingly concentrated onto the support post 23, because the leg pillar 244 is extendedly disposed to the central line of support post 23, it can directly bear the concentrated weight of support post 23 without causing a bending moment, and then the ground-contacting member 245 will vertically pass the supported weight of support plate 10 to the ground, such that the leg pillar 244 and the ground-contacting member 245 thereof can support the user's weight so as to reduce the loading weight of the leg racks 242 of the chair, thus enabling to prolong the service lives of the leg racks 242, and the leg 24 can be made of cheaper plastic material, such as polypropylene, so as to greatly diminish the material cost thereof.

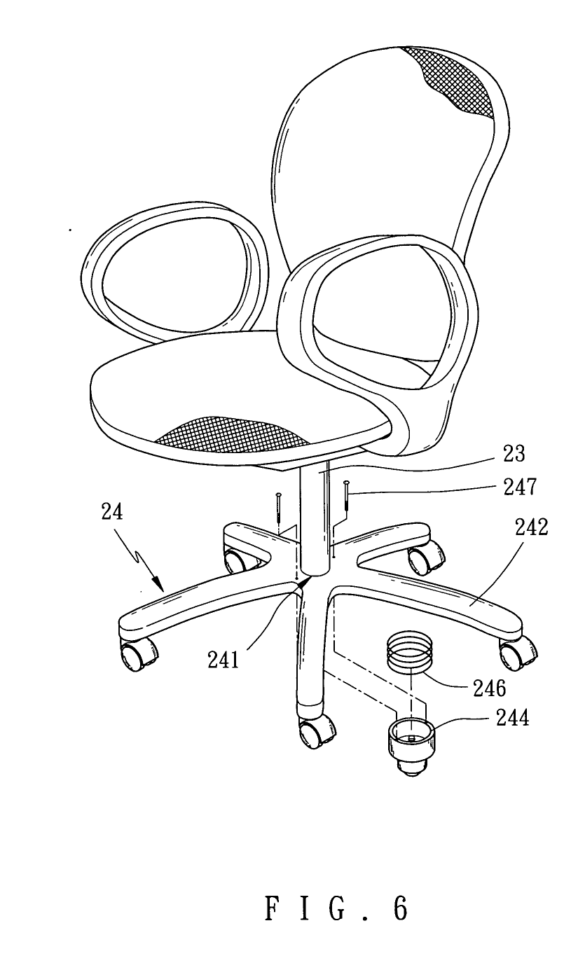

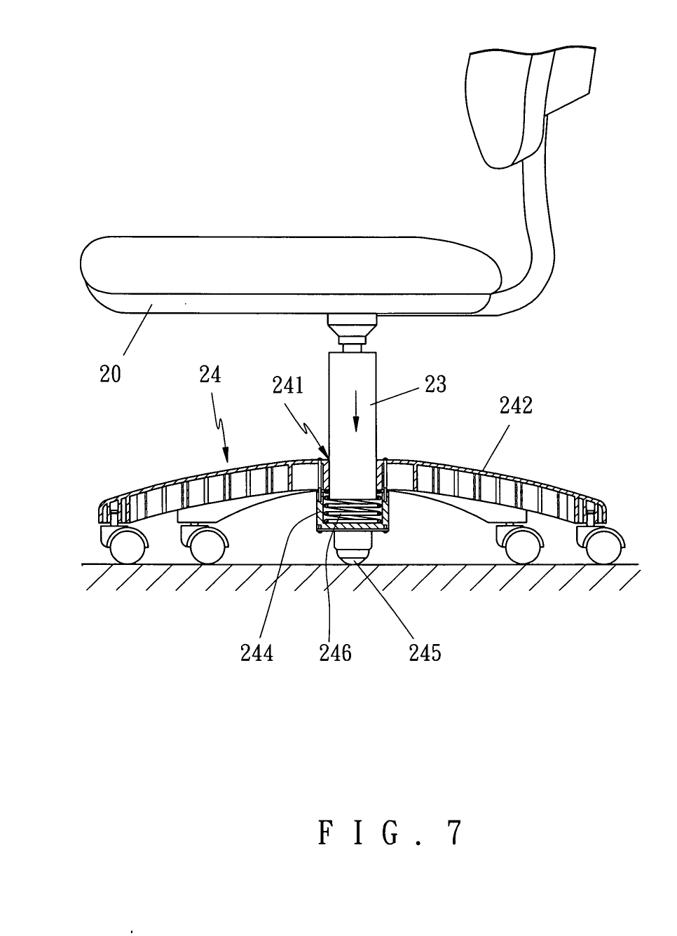

With reference to the FIGS. 6 and 7, a leg structure of an office chair in accordance with a first preferred embodiment of the present invention comprises a leg pillar 244 having a compression spring 246 therein extendedly provided at the lower side of a fitting portion 241 of a leg 24, wherein the upper end portion of the compression spring 246 biases against the periphery of the fitting portion 241. By using bolts 247, the leg pillar 244 can be fixed to the leg 24, and a ground-contacting member 245 is arranged at the lower side of leg pillar 244 in such a manner that the partial supported weight of the support post 23 can be absorbed, thereby obtaining the stable support for the leg pillar 244 and the grounding-contacting member 245.

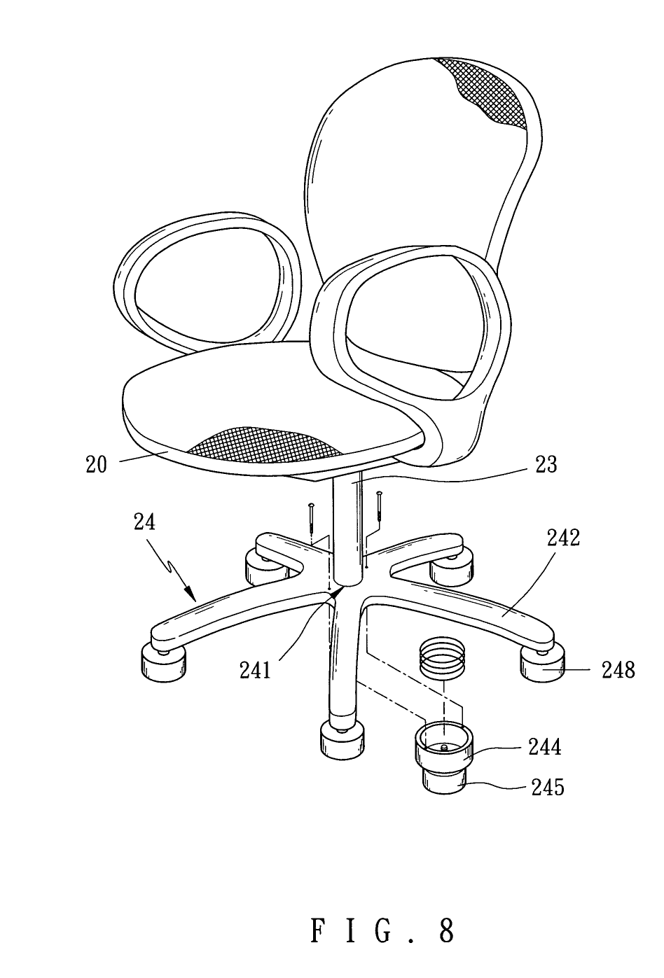

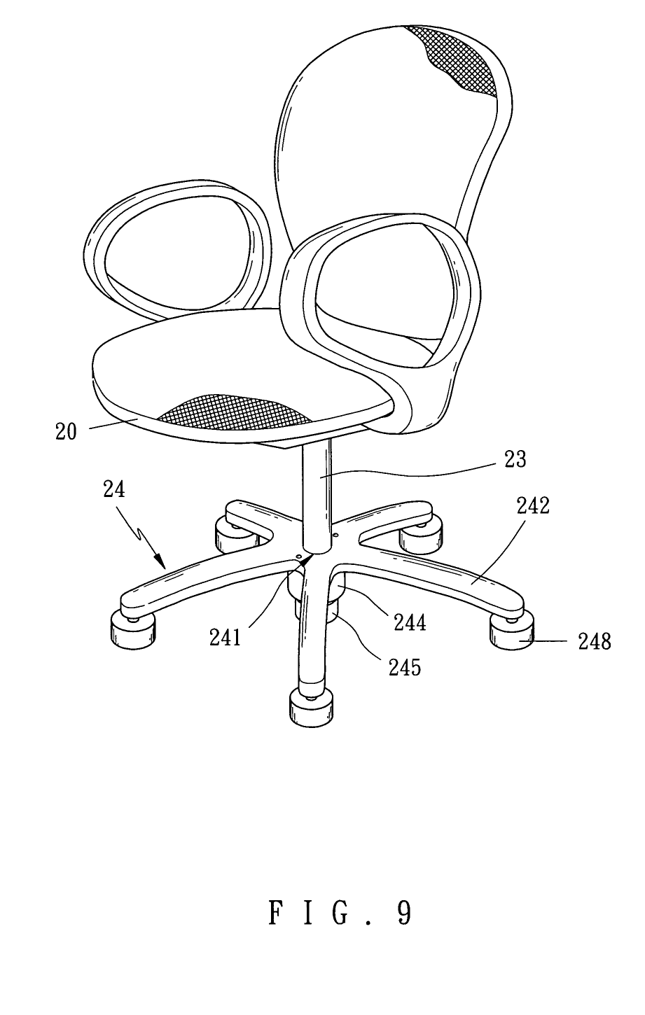

As shown in FIGS. 8 and 9, a leg structure of an office chair in accordance with a second preferred embodiment of the present invention includes a padding block 248 formed at the lower side of the outer end portion of each of racks 242 for the prevention of random sliding of the chair such that a fixed-type chair is achieved, wherein an upright leg pillar 244 is extendedly disposed at the lower end of the fitting portion 241 of the leg 24, and a ground-contacting member 245 is mounted beneath the leg pillar 244 for abutting against the ground, in addition, the ground-contacting member 245 can be a rotatable sliding wheel or a wear-proof padding block, thus enabling to prolong the service lives of the leg racks.

While we have shown and described various embodiments in accordance with the present invention, it should be clear to those skilled in the art that further embodiments may be made without departing from the scope of the present invention.

What is claimed is:

1. A leg structure of an office chair comprises a vertical support post coupled to the bottom of a support plate of a chair, a leg coupled to the lower portion of said support post, wherein said leg is defined with a fitting portion for the connection with said support post, at the periphery of said fitting portion is radially arranged a plurality of leg racks, and beneath the end of each of said leg racks is provided with a sliding wheel, thus achieving a moveable chair, the main characteristics of said leg structure of said office chair being to provide a ground-contacting member mounted beneath said fitting portion of said leg for abutting against the ground.

2. The leg structure of the office chair as claimed in claim 1, wherein said grounding-contacting member can be a randomly-rotatable sliding wheel or a wear-proof padding block.

3. The leg structure of the office chair as claimed in claim 1, wherein an upright leg pillar is extendedly disposed at the lower end of said fitting portion of said leg, and another ground-contacting member is mounted beneath said leg pillar for abutting against the ground.

4. The leg structure of the office chair as claimed in claim 3, wherein said leg pillar can also be integrally formed with said leg.

5. The leg structure of the office chair as claimed in claim 3, wherein said leg pillar is extendedly disposed to the central line of said support post, it can directly bear the concentrated weight of said support post.

6. The leg structure of the office chair as claimed in claim 3, wherein said leg pillar is interiorly defined with a compression spring, the upper end portion of which biases against the periphery of said fitting portion.

7. The leg structure of the office chair as claimed in claim 6, wherein said leg pillar can be fixed to the bottom of said leg by using bolts.

8. A leg structure of an office chair comprises a vertical support post coupled to the bottom of a support plate of an chair, a leg coupled to the lower portion of said support post, wherein said leg is defined with a fitting portion for the connection with said support post, at the periphery of said fitting portion is radially arranged a plurality of leg racks, and beneath the end of each of said leg racks is provided with a padding block, thus achieving a fixed chair, the main characteristics of said leg structure of said office chair being to provide a ground-contacting member mounted beneath said fitting portion of said leg for abutting against the ground.

9. The leg structure of the office chair as claimed in claim 8, wherein said grounding-contacting member can be a randomly-rotatable sliding wheel or a wear-proof padding block.

10. The leg structure of the office chair as claimed in claim 8, wherein an upright leg pillar is extendedly disposed at the lower end of said fitting portion of said leg, and another ground-contacting member is mounted beneath said leg pillar for abutting against the ground.

11. The leg structure of the office chair as claimed in claim 10, wherein said leg pillar can also be integrally formed with said leg.

12. The leg structure of the office chair as claimed in claim 10, wherein said leg pillar is extendedly disposed to the central line of said support post, it can directly bear the concentrated weight of said support post.

13. The leg structure of the office chair as claimed in claim 10, wherein said leg pillar is interiorly defined with a compression spring, the upper end portion of which biases against the periphery of said fitting portion.

14. The leg structure of the office chair as claimed in claim 13, wherein said leg pillar can be fixed to the bottom of said leg by using bolts.
